(19) United States
(12) Patent Application Publication
(10) Pub. No.: US 2008/0299021 A1
(43) Pub. Date: Dec. 4, 2008

(54) SYSTEM FOR THE PRODUCTION OF SYNTHETIC FUELS

(76) Inventors: Jack W. Boykin, Montrose, AL (US); Allen W. Boykin, Daphne, AL (US)

Correspondence Address: Husch Blackwell Sanders, LLP;Welsh & Katz, 120 S RIVERSIDE PLAZA, 22ND FLOOR, CHICAGO, IL, 60606, US

(21) Appl. No.: 12/111,849

(22) Filed: Apr. 29, 2008

Related U.S. Application Data
(63) Continuation-in-part of application No. 11/768,097, filed on Jun. 25, 2007.
Application No. 11/768,097 is a continuation-in-part of application No. 11/768,057, filed on Jun. 25, 2007.
Application No. 11/768,057 is a continuation-in-part of application No. 11/768,073, filed on Jun. 25, 2007.
Application No. 11/768,073 is a continuation-in-part of application No. 60/927,552, filed on May 4, 2007.

(51) Int. Cl. B01J 19/00

(52) U.S. Cl. 422/213

(57) ABSTRACT

A system and method for producing synthetic fuels are disclosed in which a slurry comprised of a particulate solid portion dispersed in a carrier liquid portion is provided. The solid portion comprises (i) a feedstock of carbon-containing polymeric materials that are substantially free of each of halogen, sulfur and nitrogen atoms, and contain about 5 to about 25 percent by weight water, and (ii) a catalytic amount of metal particles. The carrier liquid portion is a hydrocarbon/oxyhydrocarbon composition. The feedstock constitutes about 10 to about 60 weight percent of the slurry. The slurry is heated anaerobically to provide an elevated temperature of about 250° to about 455° C. and a pressure of about 20 to about 50 atmospheres that are maintained for a time period sufficient to provide a combustible liquid fuel at least 80 percent of which contains about 6 to about 21 carbon atoms per molecule.

### CROSS REFERENCE TO RELATED APPLICATIONS

This application is a continuation-in-part of each of application Ser. No. 11/768,097, Ser. No. 11/768,057 and Ser. No. 11/768,073 that all were filed on Jun. 25, 2007 and claim priority to provisional application Ser. No. 60/927,552 filed on May 4, 2007, the contents of which are incorporated herein by reference.

### BACKGROUND OF THE INVENTION

Wood and coal have been a principle source of fuel for hundreds of years. In modern times, petroleum has become a primary commodity for the generation of energy. Petroleum has had the advantages of relatively low cost and ease of transportation and storage because of its liquid consistency. Further, petroleum is readily amenable to fractionation and conversion into a variety of valuable industrial products such as fuels, building products, chemical intermediates and the like.

International developments have led to increase in the price of this crude oil. The consumption of petroleum has been increasing exponentially and concomitantly the readily available world petroleum supply has diminished. Governments and industrial concerns are dedicating increased attention to alternatives to petroleum as sources for fuels and chemical intermediates.

In recent years, the world has seen many innovations in “green” technologies, including methods for making synthetic fuels for transportation and heat utilizing the enzymatic and bacterial decomposition of cellulose and starch material to ethanol or similar alkanol products. Vegetable oils of many varied plant sources have been converted to alkyl esters. Although these processes are clean and environmental friendly and can provide an alternative source of synthetic fuel, the use of edible plants inevitably leads to the increase of price for food supply. Moreover, many of these plants require high energy costs during the planting, harvesting and processing phases.

New programs are being developed for the provision of carbonaceous fuel products which complement and enhance conventional petroleum or coal-derived energy sources. Processes for liquefying coal or the gasification and then condensation of other carbon-containing materials have been proposed. However, these processes have not been deemed to be fully satisfactory for various cost or environmental reasons. There remains a pressing need for new technology that can deliver high quality fuels at economically and environmentally favorable levels, while maintaining atmospheric carbon neutrality.

Accordingly, it is desirable to provide a system and process of producing liquid synthetic fuels that overcomes drawbacks of conventional systems and methods of producing synthetic fuel.

Other objects and advantages of the present invention shall become apparent from the accompanying description and examples.

### BRIEF SUMMARY OF THE INVENTION

In accordance with the invention, a system and method for producing synthetic fuels, especially those that are essentially chemically identical to conventional vehicle fuels, is provided in which a feedstock comprised of carbon-containing polymers from one or more of a wide variety of sources is re-formed into a more satisfactory liquid fuel source for producing heat, electricity, powering vehicles and the like. The feedstock can comprise scrap rubber, plastic and/or organic matter or other materials that are not particularly well suited for use as fuels in their existing state.

The system and method contemplate breaking relatively long, usually solid carbon-containing synthetic polymer and/or natural polymer molecules of a feedstock into shorter carbon chain moieties and then polymerizing or otherwise reforming those short chain moieties and forming a liquid fuel comprising a mixture of compounds comprised of hydrocarbons such as straight, branched and mono- and polycyclic alkanes, alkenes, and alkynes, as well as oxygenated hydrocarbons such as alcohols, ketones, aldehydes, carboxylic acids, ethers and esters of selected length. This mixture of fuel components is collectively referred to as hydrocarbon/oxyhydrocarbon compounds. The words “solid” and “liquid” refer to physical states at ambient room temperature; i.e., about 20° C., and one atmosphere of pressure.

Reactions in accordance with preferred embodiments of the invention do not involve a net addition of oxygen to the system, can be considered anaerobic, and usually remove oxygen present from the polymer. A reaction in accordance with preferred embodiments of the invention usually utilizes much less water than many conventional methods.

A process in accordance with a preferred embodiment of the invention typically utilizes physical reduction of the size of the various solid components; drying or wetting those components to a controlled water level; liquefying reactions where components are broken down to form shorter chained moieties; removal of oxygen atoms from carbohydrates and/or saturation of unsaturated bonds from hydrocarbon compounds; and recombination of formed short chain species to form molecules having predetermined, desired numbers of carbon atoms to make synthetic fuels that include one or both of hydrocarbons or oxygenated hydrocarbons.

A feedstock in accordance with the invention can include a wide variety of sources of biomass including one or both of lignin and a naturally occurring polysaccharide material such as cellulose and hemicellulose polymers, as well as one or more synthetic carbon-containing polymeric materials. It is preferred that the feedstock be provided reduced in size, into particles that are preferably less than about 1,000 microns in the largest dimension, more preferably less than about 500 microns and most preferably less than about 300 microns. This size reduction can be done in multiple stages with the final reductions in size preferably carried out with the feedstock as a solid component dispersed in an organic liquid carrier that is a hydrocarbon/oxyhydrocarbon composition to form a slurry.

The weight percentage of feedstock in the slurry can be about 10% to about 60%, with percentages of about 40% to about 50% being preferred. The liquid for the slurry is preferably a hydrocarbon/oxyhydrocarbon composition such as the recycled hydrocarbon/oxyhydrocarbon fuel product from the synthetic fuel process. However, other liquids such as No. 2 diesel fuel are also useful.

The particulate, polymeric feedstock is combined with a metal catalyst or initiator, such as a Group VIII, IB, IIB, IIIA, IVA metal or in particular, platinum, iron, aluminum, zinc, copper and the like. The catalyst is present in an amount of up to about 10 percent by weight of the feedstock. A preferred source of the metal catalyst comes from ground up automobile tires.

The feedstock/catalyst mixture dispersed in a liquid as a slurry is subjected to the controlled application of high temperature and pressure to liquefy and reform the feedstock. High temperature and pressure can be used to help break feedstock polymer molecules into short chain moieties, that contain 2- to about 9-carbon atoms. Most, if not all of the original oxygen present in the carbon-containing polymeric feedstock is removed during the reforming process. The short chain hydrocarbons are advantageously combined into hydrocarbons/oxyhydrocarbons of a predetermined, selected carbon content; i.e., average number of carbon atoms in molecules of the resulting mixture.

Processes in accordance with the invention are preferably conducted in substantially airtight conditions. It is preferred to put the feedstock into a non-aqueous slurry, with the liquid phase comprising a hydrocarbon/oxyhydrocarbon composition that has the viscosity and boiling characteristics of gasoline (boiling range at 1 atmosphere of 40 to about 205° C.) to those of lubricating oil (boiling range of about 300 to about 370° C.). A particularly preferred hydrocarbon/oxyhydrocarbon composition is No. 2 diesel fuel (boiling range of about 285° to about 340° C.) or an oxygen-containing hydrocarbon such as an ester such as butyl phthalate or butyl sebacate, having a similar boiling point to the diesel fuel.

In a preferred embodiment of the invention, the chemical reactions take place in an organic liquid phase. The hydrocarbon/oxyhydrocarbon output of reactions in accordance with the invention can be recycled and used as the organic liquid, such as that combined with the initial feedstock, to ensure a substantially air free system and to assist in the downsizing of the feedstock solids. The recycled hydrocarbon/oxyhydrocarbon output is at elevated temperature. Thus, the recycled stream can aid in the initial elevation of feedstock temperature and reduces instances of charring. Recycling the output can also lead to branched chain hydrocarbons, which tend to increase octane or cetane ratings of the fuels produced.

The invention can be carried out using multiple reactors, with three as a preferred number. In a first reactor, the feedstock can be substantially, at least about 80%, liquefied. This liquification can involve breaking intermolecular and intramolecular bonds and reducing the size of the feedstock molecules and polymers. The output temperature is about 250° F. (121° C.) to about 450° F. (230° C.), and the pressure is about 5 to about 15 atmospheres. In a second reactor, additional bonds are advantageously broken and the feedstock material can be transformed into shorter chain moieties. Deoxygenation takes place to replace hydroxyl groups with hydrogen. The output temperature is about 500° F. (260° C.), with a pressure of about 25 atmospheres. Finally, those moieties can be formed into polymerized or otherwise reformed hydrocarbons and oxyhydrocarbons of predetermined selected length (number of carbon atoms) in the third reactor, the output temperature of which is about 700° F. (370° C.) to about 850° F. (455° C.) and a pressure of about 30 to about 55 atmospheres.

Preferred reactors are in the form of horizontal tubes. The tubes are preferably formed of steel, stainless steel or other appropriate metal that can withstand the temperatures and pressures of the reaction without substantial degradation. The tubes are capable of containing liquid at about 850° F. (455° C.) and a gauge pressure of about 55 atmospheres. An internal screw is preferably used to move the reactants in plug-flow, through the reactor at controlled speeds. Electrical heating elements on the reactor surfaces advantageously control the temperature of the reactors, although other sources of heating such as pressurized steam, flame and the like are also contemplated. Measuring the temperature and viscosity at the output can provide valuable feedback for controlling the heating elements and screw speed.

It is believed that the metal particles in the slurry react with the water in the feedstock to yield metal oxides and hydrogen. At the temperatures involved, ranging from over about 250° F. (120° C.) to 450° F. (230° C.) and above, the free hydrogen is believed to attack (saturate) double bonds created by the metal catalyst in the feedstock material. The metal catalyst particles also assist in reducing the size of the feedstock molecules and promote the liquefaction of the feed stream. Increasing the temperature, either in the same or in a separate reactor, further breaks down the feed material into small chain hydrocarbon moieties, advantageously containing 2- to about 9-carbons. Molecular size of the reformed product can be predetermined (adjusted) by controlling the temperature, pressure, reactor time and the amount of metal added. Thus, at a constant reaction time, increasing the temperatures from about 260° C. to about 425° C. and pressures of about 20 to about 50 atmospheres provides a mixture of product compounds having about equal amounts of C12 and C14-18 species, with small amounts of C6-8 species changing to a product mixture having significant amounts of C6 species, major amounts of C8-12 species and almost no product having 14-18 carbons. Shorter reaction times at the higher temperatures and pressures provide more of the higher molecular weight product species.

By adjusting reaction temperatures and pressures, at least 80% if not substantially all of the output can be gasoline, diesel fuel or aircraft fuel. The bulk of a typical gasoline consists of a mixture of hydrocarbons with between 5 and 12 carbon atoms per molecule. On the other hand, No. 2 diesel fuel has a range of about 12 top about 21 carbon atoms per molecule, with some unsaturation or ring structures present.

In another embodiment of the invention, the output can be blended as more than least 5% or 10% with one of these fuels. The resulting product can be used as is or further refined or purified. It can also be advisable to employ a mechanism, such as a shockwave producer, to break up any relatively long chain hydrocarbons, such as waxes, that might be in the final product.

The invention accordingly comprises the several steps and the relation of one or more of such steps with respect to each of the others, the system embodying features of construction, combinations and arrangement of parts which are adapted to effect such steps, and the product which possesses the characteristics, properties, and relation of constituents (components), all as exemplified in the detailed disclosure hereinafter set forth, and the scope of the invention will be indicated in the claims.

### BRIEF DESCRIPTION OF THE DRAWINGS

For a fuller understanding of the invention, reference is had to the following description, taken in connection with the accompanying drawings, in which:

FIG. 1 is a schematic diagram of a system for producing synthetic fuels, in accordance with preferred embodiments of the invention;

FIG. 2 is a schematic diagram of a size reduction section of the system of FIG. 1;

FIG. 3 is a schematic diagram of a reaction section of the system of FIG. 1;

FIG. 4 is a schematic diagram of a finishing section of the system of FIG. 1;

FIG. 5 is a chemical drawing of the chemical breakdown of cellulose from biomass to aldotriose and/or aldohexose; and

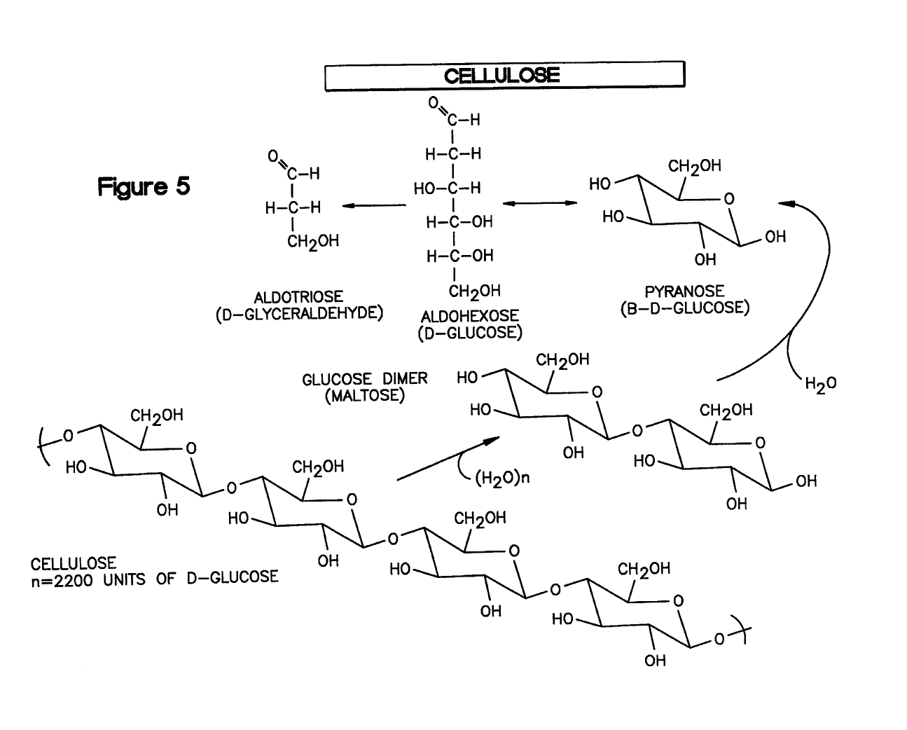

FIG. 6 is a chemical drawing of bond cleavage when butadiene containing tires are used.

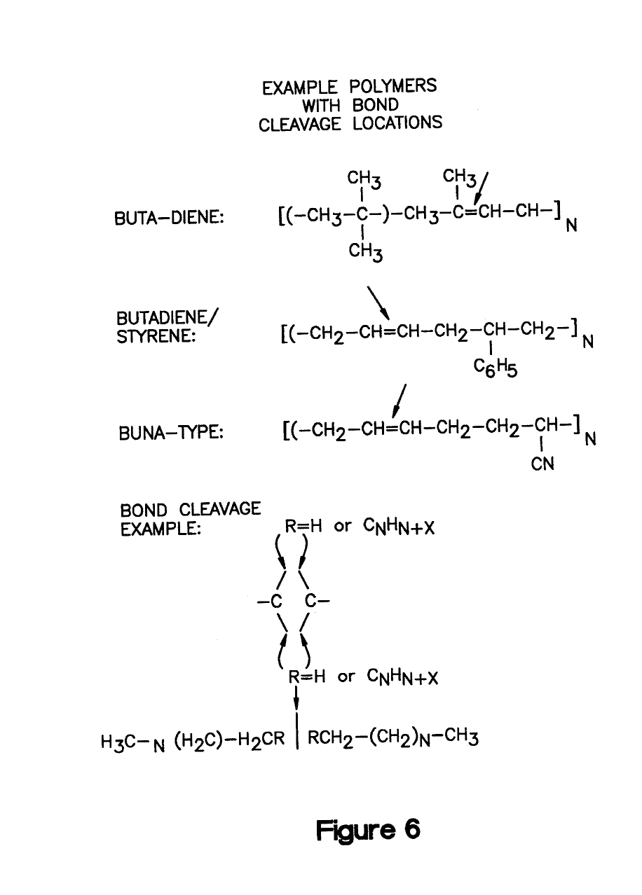

### DETAILED DESCRIPTION OF PREFERRED EMBODIMENTS

As discussed herein, a system and method are provided for converting a carbon-containing polymeric feedstock comprised of materials such as rubber, cellulosic and hemicellulosic and plastic materials into a synthetic fuel such as a synthetic form of gasoline, diesel, kerosene and home heating fuel, often referred to herein as a “feedstock”. The polymeric raw material is depolymerized to low molecular weight intermediates and then re-combined to a predetermined, controlled molecular weight mixture of carbon-containing species, which is similar to the molecular structures of gasoline, diesel or other fuel.

A contemplated process combines pressure, heat and chemical catalysts. Specifically, the process combines the following general steps: (i) size reduction process that reduces feedstock materials to a low-micron level particle; (ii) liquefaction reactor system which reduces the feedstock to short chain monomers; (iii) second stage processing system which recombines the monomers into synthetic gasoline (based on a 6-12 carbon chain molecule), diesel fuel (based on a 12-21 carbon chain molecule), or jet fuel (based on a 12-18 carbon chain molecule); and (iv) transfer and storage tanks for final products. Processes and systems in accordance with the invention can be used to produce about one gallon of synthetic fuel from about 12 to 15 pounds of dry cellulose or plastic polymer.

The process can be highly environmentally friendly. The process can be anaerobic and anhydrous (non-aqueous carrier liquid) which creates negligible amounts of carbon dioxide, a major byproduct of many competing processes, and the anhydrous process generates no wastewater.

Fuels produced can have boiling points of 3000 to 700° F., room temperature viscosities of about 1 to about 200 cps and are suitable for a variety of uses.

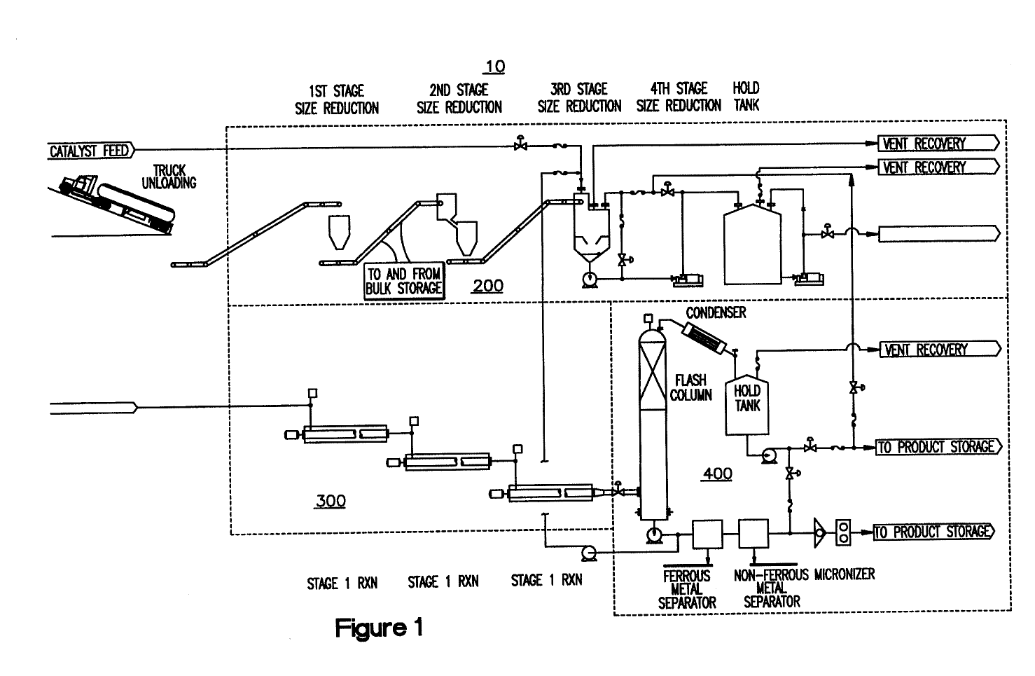

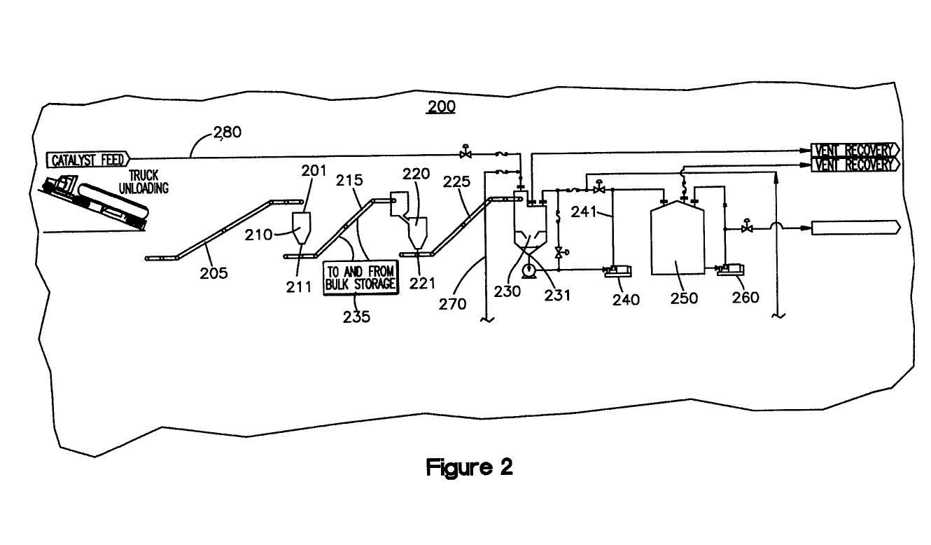

FIG. 1 is a schematic view of a fuel production plant (10) in accordance with a preferred embodiment of the invention. The plant (10) comprises three general process sections: a size reduction section (200), a reaction section (300) and a finishing section (400), each shown in greater detail in FIGS. 2, 3 and 4, respectively.

One preferred embodiment of the invention utilizes a size reduction step having multiple stages to reduce, preferably gradually, the size of the carbon-containing polymer feedstock to the desired particle size. It is preferred that the feedstock be present in the slurry in particulate form at a particle size of about 1 inch (about 2.54 cm) in the longest dimension or less.

Referring to FIG. 2, size reduction section (200) preferably comprises a first stage size reduction grinder (210), a second stage size reduction grinder (220), a third stage size reduction grinder (230), a fourth stage size reduction safety grinder (240) and a slurry storage tank (250). Acceptable grinders in accordance with preferred embodiments of the invention include the MultiShear and Arde Barinco brand grinders, from MultiShear Corporation of Graniteville, South Carolina and Arde Barinco, Inc. of Norwood, N.J.

A size reduction process can begin when a truck or other vehicle delivers a variety of feedstock to plant (10) or when the materials are reduced in size off site. A feedstock (201) is placed on a first conveyor belt (205), which carries the feedstock upon unloading to first stage size reduction grinder (210). The output of first stage size reduction grinder (210) is placed on a second conveyor belt (215), which carries once-reduced feedstock (211) to second stage size reduction grinder (220). Similarly, the twice-reduced output 221 of second stage size reduction grinder (220) is placed on a third conveyor belt (225) and transported to third stage size reduction grinder (230). Optionally, a storage tank, such as tank (235), can be added to store once-reduced output (211) of first stage size reduction grinder (210) or twice-reduced output (221) of second stage size reduction grinder (220). The three times reduced output (231) from third stage size reduction grinder (230) can be fed into fourth stage size reduction safety grinder (240) to insure substantially complete size reduction before a slurry output (241) is being stored in slurry storage tank (250). Alternatively, output (231) can be stored in slurry storage tank (250) without being fed into fourth stage size reduction safety grinder (240). Safety grinder (240) is optionally attached to slurry storage tank (250) to ensure uniformity of particles of less than about 300 microns before the slurry enters the reaction section (300).

One purpose of the size reduction process of section (200) is to decrease the size of the feedstock pieces, preferably gradually, to desirable sizes, preferably less than 300 microns. In one embodiment, the feedstock is first ground to ½ inch to 1 inch pieces in first stage size reduction grinder (210), then to ⅛ inch to ⅜ inch size particles in second stage size reduction grinder (220) before entering third stage size reduction grinder 230. Both first second stage reduction grinder (210) and second stage reduction grinder (220) can be operated while the feedstock remains dry. In contrast, twice-reduced feedstock (221) is preferably combined with liquid to form a slurry form when it enters third stage grinder (230) and fourth stage safety grinder (240).

A contemplated feedstock can include naturally occurring biomass that contains one or both of lignin and polysaccharide materials such as cellulose and hemicellulose polymers, as well as chemically modified polysaccharides such as methyl cellulose, cellulose acetate, rayon and the like (collectively referred to herein as cellulosic material). These sources can further include various biomass sources, including wood chips, sawdust, brush, hay, straw, switch grass, corn stalks, kudzu and other sources of cellulosic material such as paper and cardboard, and mixtures thereof.

The sources of cellulosic material can be permitted to dry or can be actively dried to a selected moisture content. Those cellulosic material sources can also be blended to result in a desired moisture content. If necessary, water can be added to overly dry feedstocks. These sources of cellulosic material and lignin can be blended with each other and with other polymer feedstocks, or used as a single uniform type of cellulose.

The process can also utilize a synthetic polymer as the feedstock carbon-containing polymeric material. The synthetic polymer can be a hydrocarbon or other polymer. For example, waste plastic such as polystyrene, polyester, polyacrylate, polyurethane, polyethylene, polypropylene and rubber, such as is present in vehicle tires can be utilized as a feedstock source. Mixtures of synthetic polymers with cellulosic material are also acceptable for use as the feedstock. Tires can include all of the polymers now used to manufacture tires, such as butadienes and fillers, such as carbon, silica, aluminum and zinc acetate.

A wide variety of synthetic carbon-containing synthetic polymer or cellulosic polymer materials, including rubber, plastic, trees, bushes, brush, bark, sawdust, wood chips, hay, straw, switch grass, field stubble, paper, cardboard and the like can be used as feedstock in accordance with the invention. However, certain materials require additional attention. For instance, bark can be used. However, because bark is high in ash and absorbs water readily, when using bark as feedstock, special attention needs to be paid to insure moisture content. Similarly, although pine saw dust can be used, it is recommended to limit the weight of pine saw dust used at less than 25% of the total feedstock weight.

The moisture content of the feedstock is of import to a contemplated process. The moisture content of the feedstock can be controlled and adjusted before or after the feedstock enters the first stage size reduction grinder (210) or second stage size reduction grinder (220). Feedstock of various moisture contents can be blended to achieve desirable average moisture content. If necessary, additional water can be sprayed or otherwise added into the system. Feedstock such as grasses, brush and wood chips can be permitted to dry before entering a process in accordance with the invention. Regardless of when the feedstock is dried or moistened, the average water content is preferably about 5 to about 25%, more preferably about 15 to about 20% and most preferably about 16 to about 17% by weight of the feedstock.

In accordance with embodiments of the invention shown in FIG. 2, the third stage grinder (230) can be constructed and arranged to receive output (221) from the second stage grinder (220) and, in addition, two additional feeds, including a liquid feed (270) and an initiator feed (280). All the inputs to third stage grinder (230) are mixed to form a slurry (231) having the above-identified water content.

The input from liquid feed (270) advantageously comprises a non-aqueous hydrocarbon/oxyhydrocarbon solvent (271). In one preferred embodiment of the invention, the hydrocarbon/oxyhydrocarbon solvent can be final output (421) of plant (10). However, it is not necessary to use a recycle of the final product, and other hydrocarbon/oxyhydrocarbon solvents can be used. Liquid feed (270) advantageously changes the viscosity of slurry (231). The addition of hydrocarbon solvent (271) fills out the available space in reactors discussed below to ensure an oxygen free environment. The liquid phase also makes size reduction easier.

A particularly useful and relatively low cost hydrocarbon/oxyhydrocarbon solvent is No. 2 diesel fuel. No. 2 diesel fuel is typically petroleum-derived and is composed of about 75% saturated hydrocarbons (primarily paraffins including n, iso, and cycloparaffins), and 25% aromatic hydrocarbons (including naphthalenes and alkylbenzenes). The average chemical formula for a molecule of common diesel fuel is C₁₂H₂₃. No. 2 diesel fuel is a mixture of hydrocarbons that typically correspond to the formula approximately C₁₀H₂O to C₁₅H₂₈. No. 2 diesel fuel typically has a boiling point of about 285° to about 340° C. (at one atmosphere), a melting point of about −30° to about −18°, and a density of about 0.87 to about 0.95 g/cm³. Characteristics of No. 2 diesel are described in IPCS (International Programme on Chemical Safety) document 1564, October 2004.

Synthetic diesel produced from the Fischer-Tropsch process is also useful. Synthetic diesel can also be produced from natural gas in the Gas-to-liquid (GTL) process or from coal in the Coal-to-liquid (CTL) process. Such synthetic diesel has about 30% less particulate emissions than conventional diesel. No. 2 fuel oil and No. 2 diesel are substantially the same and have a flash point of 52° C.

This solvent phase should, however, while mostly comprising organic solvent, contain controlled amounts of water. The water can act as a source of hydrogen for aiding the reduction of molecular size. Water content is preferably about 25% to about 5%, more preferably about 15% to about 20%, and most preferably about 16% to about 17% of the feedstock.

Initiator feed (280) introduces initiator/catalyst particles (281) to the input of third stage grinder (230). Initiators can include elements of Group IB, IIB, IIIA, IVA, VB, VIIB, VIIB and Group VIII. Preferred initiators include Group IB (copper, silver and gold), IIB (zinc, cadmium and mercury) and VIII (iron, ruthenium, osmium, cobalt, rhodium, iridium, nickel, palladium, platinum) metals. Exemplary preferred initiators include platinum, iron, aluminum, aluminum silica, zinc and copper. An initiator/catalyst comprised of particles of one or more Group VIII metals is particularly preferred. The metal initiator/catalyst can be provided as a metal powder with substantially all, but at least 80% of the particles having a diameter (or largest dimension) of less than about 1000 microns (passes through a No. 18 Standard Sieve), preferably less than about 500 microns (passes through a No. 35 Standard Sieve), more preferably about 300 microns (passes through a No. 50 Standard Sieve) or less.

The initiator can be provided as pure metal powders. Alternatively, polymeric materials, such as used tires, can be used to provide the metal initiator.

A preferred source of the metal catalyst comes from ground up tires, e.g., tires used on an automobile, truck, aircraft, construction equipment, military vehicle and the like. Conventional automobile tires include steel belts. These belts are commonly formed from iron-containing wire that is coated with copper, which in turn, can be coated with zinc. A steel-belted tire typically contains about 20 to about 25% by weight iron, and that amount can be used in determining the amount of initiator/catalyst present at the beginning of a reaction. The steel belts in tires contain iron that can be coated with copper and/or zinc. The synthetic rubber itself includes aluminum and silica materials. All the metals in the tire can serve as initiators.

In a preferred embodiment of the invention, essentially all, but at least 80% of the tires are ground into smaller pieces, preferably in multiple stages, to a size less than about 1,000 microns, more preferably less than about 300 microns and most preferably about 500 microns or less. This size reduction results in the production of metal particles in the above sizes. The final size reductions advantageously take place in a slurry.

The process described herein can use automobile, tractor and truck tires or general plastic polymer waste as sources of plastic, carbon, iron and copper. The plastic polymers of butadiene, styrene/butadiene, Buna N, Neoprene, polyesters, polyurethanes and others depending on the manufacturers polymer blend can be depolymerized and serve as sources of carbon-containing polymer radicals to form iso, secondary, and other polymers with the intermediate unsaturated polymers formed from cellulose. Halogen-containing polymers, sulfur-containing polymers and nitrogen-containing polymers are preferably not used as part of the feedstock. The polymeric materials of the feedstock are substantially free of halogen, sulfur and nitrogen atoms and can contain up to about 10 weight percent by weight of all of those atoms when calculated together. Preferably, the total weight percentage of all of the halogen, sulfur and nitrogen atoms in the polymeric feedstock is less than about 5 percent. The metals can react with the water and cellulose to remove oxygen and form in situ hydrogen. The metal oxides can be removed from the process slurry and sold as a by-product. Tires and plastics can be used as 100% of the raw material or some lesser percentage. The presence of the tires and plastics reduce the amount of catalysts and carbon needed for the process.

Initiator/catalyst (281) is added to the third stage grinder (230). Regardless of the source of initiator (281), it should have a particle size less than about 1000 microns, preferably less than 500 microns and more preferably about 300 microns or less. The smaller size can lead to a more optimal reaction rate because of the increased surface area. Initiator/catalyst (281) is present in an catalytic amount that typically comprises more than 1% by weight of feedstock (201), preferably more than 3% and most preferably 5% or more preferably up to about 10% by weight of feedstock.

Once feedstock (201) has undergone size reduction, the slurry output (231) is fed into slurry storage tank (250). The slurry output (231) can then be utilized in a chemical reaction process in reaction section (300).

Preferred embodiments of the invention comprise a reaction section (300). Preferred processes can involve multiple reaction stages in multiple reactors (2, 3, 4 or more) to break down feedstock into short chain carbon radicals. Those radicals, preferably 2- through 9-carbon chains, e.g., 2-, 3-, 4-, 5-, 6-, 7-, 8- and 9-carbon chains, repolymerize to form a liquid, burnable synthetic fuel as a final output (421) of the plant (10). Such fuels can be prepared to be identical to conventional vehicle fuels refined from crude oil.

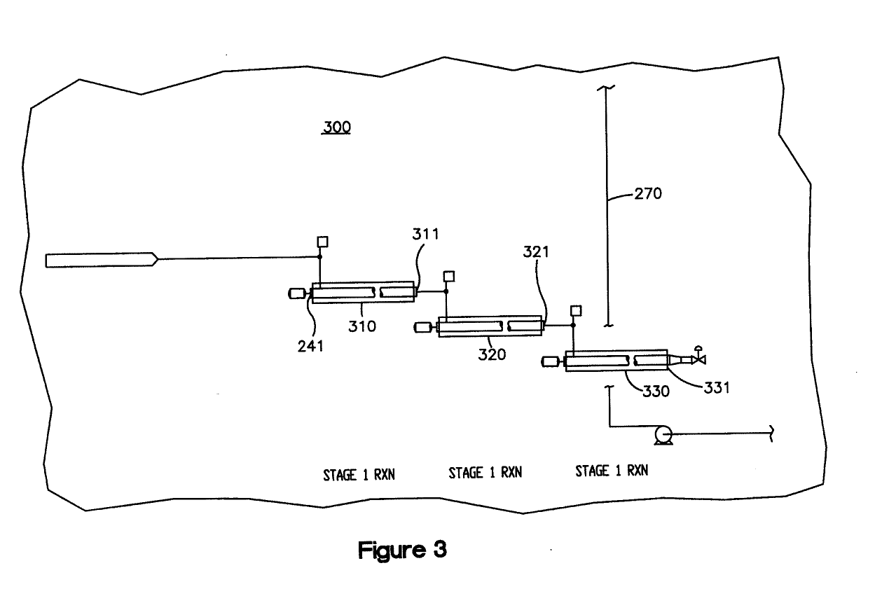

Referring to FIG. 3, the reaction section (300) preferably comprises a first reactor (310), a second reactor (320) and a third reactor (330) linked in series. Optional systems and methods can involve fewer or more reactors. Each reactor is preferably in the form of a horizontal tube. Preferred sizes are about 30 feet in length with a 2.5 foot inside diameter (about 12:1 length:diameter). Lengths and diameters (widths) of the reactors vary depending on plant production capacity. However, a length to diameter ratio of about 5:1 to about 20:1 is acceptable with about 10:1 to 15:1 being preferred. An internal screw (auger) is used to move the reactants in plug-flow, through the reactor at controlled speeds. The screw is of a variable speed so that time of plug flow through the reactor can be adjusted despite changes in flow volume and reaction rates.

Electrical heating elements on the reactor surfaces advantageously control the temperature inside the reactors, permitting a gradual and uniform rise in temperature across the length of the reactor, while minimizing fire hazard from an open flame. Super heated steam and open flames can also be used to heat the reactor. Viscosity is generally proportional to molecular size. Thus, viscosity measurements are advantageously taken at the output of each reactor and analyzed, in order to adjust the heating elements and screw speed, to provide the optimal reaction time, temperature and pressure. Temperature can be measured at the input, output and at intermediate points. The viscosity measurements can be used to affect the heating elements and screw speeds to adjust residence times and reactor temperature as needed. The reactants can spend between 10 to 15 minutes, preferably a residence time of about 11 to 13 minutes in each reactor.

Each reactor should be sealed off from the atmosphere and pressurized to ensure an anaerobic reaction with no added atmospheric oxygen. In addition, each reactor is adapted to contain a flammable liquid at a temperature of over 455° C. and at a gauge pressure of about 5,500 kPa. However, the pressure in each reactor need not be specifically controlled. Rather, pressure can be the result of the increase in temperature. Because of the lack of oxygen and the ability to control surface temperature of the reactors, there is relatively negligible char build-up after reactions to require extensive and frequent cleaning. In addition, the auger tends to provide a constant cleaning function.

The goal of the first reactor (310) and second reactor (320) is to liquefy and break down the feedstock polymers to short chain molecules, including monomers and monomer radicals. In one embodiment of the invention, to begin reaction, slurry output (241) is heated to about 250° F. (120° C.) at a gauge pressure of about 690 kPa (100 psig) and fed into first reactor (310). The temperature increase can be achieved in various ways, preferably by recycling hot liquid or slurry streams from other parts of plant (10). While in the first reactor (310), the temperature of the reactants continues to rise, resulting in a liquefied output (311) with the temperature about 450-500° F. (230-260° C.) at a gauge pressure of about 3,500 kPa (500 psig). During the residence time in the first reactor (310), various solids of slurry output (241) are liquefied by the reactions at increasing temperature and pressure. Speed and temperature are preferably adjusted so that no more than a trace of non-liquid material leaves the first reactor (310).

The second reactor (320) is constructed and set up in a similar manner as the first reactor (310). Liquefied output (311) from first reactor (310) enters second reactor (320) at a temperature of about 450° F. (230° C.) and a gauge pressure of about 3,500 kPa (500 psig). Generally, unlike the endothermic reaction in first reactor (310), because the reaction in second reactor (320) is typically exothermic, no additional heat is typically needed except for the purpose of maintaining constant temperature and controlling reaction rate.

It is believed that while in first reactor (310), as the temperature increases from about 250° F. (120° C.) to 450° F. (230° C.), the metal initiator/catalyst (281) begins to react with available water in the feedstock to become oxidized by freeing hydrogen in water, creating free hydrogen. The free hydrogen, along with high temperature and pressure, liquefies solids in slurry output (241) by attacking the bonds in hydrocarbon polymers and in cellulosic materials to make shorter chain molecules and promote the liquefaction of the feed stream. When carbon-carbon bonds are cleaved, more hydrogen is produced. About 50-70% of the breakdown of plastic and cellulosic materials to short chain molecules can occur in the first reactor (310).

### Reforming:

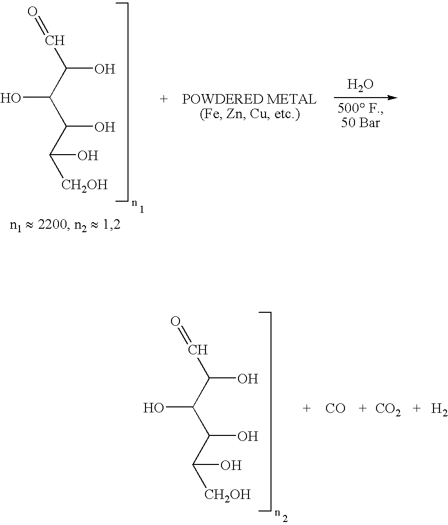

Once liquefied output (311) enters the second reactor (320), components are believed to continue to be broken down into short molecular links and further into intermediates through the process of dehydration on the surface of the particulate initiator (281). The length of carbon chains can be altered and controlled by changing the temperature, reactor residence time and amounts of initiator (281) added.

The hydrogen created in the reactor (310) is believed to react with intermediates to saturate double bonds to form alkyl hydrocarbon radicals. These hydrocarbon radicals, preferably 2-, 3-, 4-, 5-, 6-, 7-, 8- and 9-carbon chains are believed to be weakly bonded to the surface of initiator (281) with unsaturated double bonds, readily available for polymerization while the oxygen from the hydroxyl groups continues to oxidize initiator (281). Some oxygen reacts with free hydrogen to form water. Some traces of alcohols such as ethanol and methanol are also formed.

### Dehydration:

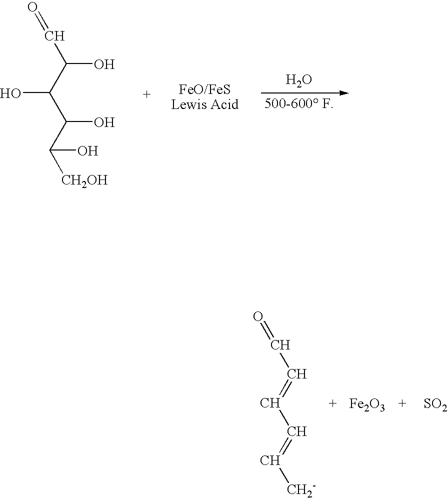

### Hydrogenation:

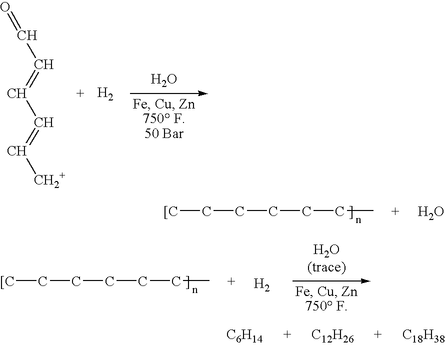

The series of reformation, dehydration and hydrogenation are self-activating because of the derivative intermediates formed. As long as the surface area of an initiator (281) plus the temperature and pressure are maintained in an appropriate balance, the cycle of reformation, dehydration and hydrogenation continue to replicate. Furthermore, dehydration and hydrogenation are both self-sustaining steps because they are exothermic reactions.

An output (321) of second reactor (320), typically comprising short chain hydrocarbon radicals as well as substantially oxidized initiator (281), exits second reactor (320) at a temperature in excess of about 260° C. up to about 650° F. (340° C.) and a gauge pressure of about 4800 kPa (700 psig) after a residence time of about 10-12 minutes in the second reactor (320). The exothermic effect of dehydrogenation provides heat to be recycled to first reactor (310) to raise the temperature of slurry output (241) from storage tank (250).

Head-to-tail polymerization of short chain carbon radicals is understood to begin automatically in the third reactor (330) as temperature is raised up to about 700° to about 800° F. At this point in the reaction, initiator (281) is thought to have been converted to a sufficiently high oxidation state or fully oxidized to become inactive as to attack bonds to create free hydrogen as experienced in first reactor (310). However, oxidized initiator particles continue to provide surface sites for the polymerization of the short chain hydrocarbon radicals into hydrocarbons of selected lengths. The length of the carbon chain of the reformed polymers can be controlled by adjusting the residence time and temperature of third reactor (330). For example, to produce gasoline, shorter molecules of 6-12 carbon atoms are best. For diesel duel, 12-21 carbon molecules and for aircraft fuel, 15-19 carbon molecules are preferred. It is also preferred that at least about 80% of the produced combustible fuel contain about 6 to about 12 carbons per molecule, about 12 to about 21 carbons per molecule or about 15 to about 19 carbons per molecule.

It is within the skill of the art to adjust time, temperature and pressure in the three reactors to adjust the output as desired. In any event, for diesel fuel, polymerization in the about 700 to about 800° F. (370-425° C.) range; gasoline, about 800 to about 850° F. (425-455° C.) and kerosene, about 750 to about 850° F. (400-455° C.) should be acceptable. The polymerization takes place at a very high temperature. Dropping the temperature lowers and stops the rate of polymerization. Some copolymerization and branched polymerization can also occur. This can be enhanced by recycling the output. This leads to enhanced octane ratings.

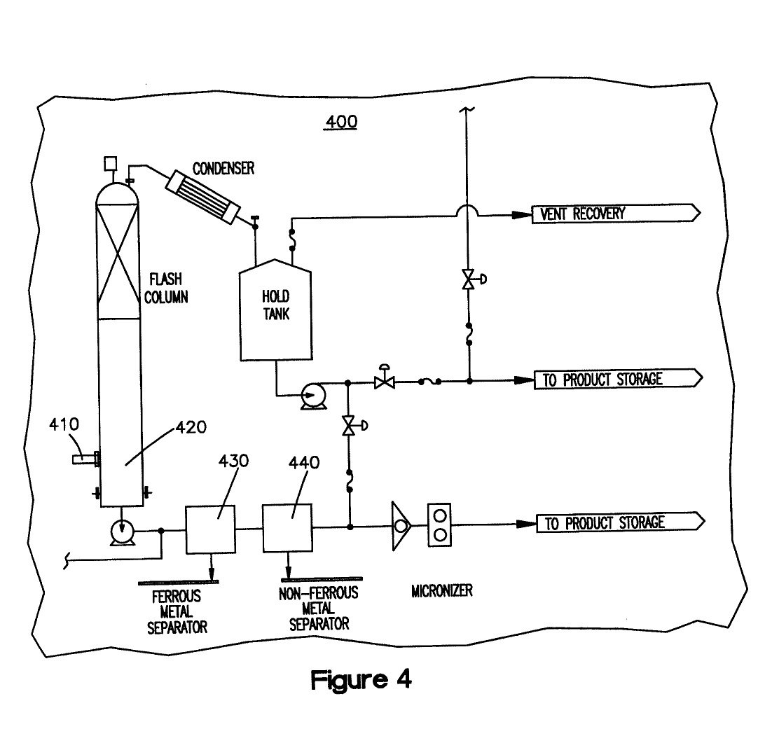

When the desired polymerization has occurred, the content of the third reactor (330), a polymerized output (331), is fed into a flash column (420) shown more clearly as part of final section (400) in FIG. 4. Optionally, before the polymerized output (331) enters the flash column (410), a shock wave device (410) is employed to use shock waves to break up long chain polymers into shorter chain polymers.

A shock wave device (410) operates at high temperatures and sends sonic waves to break up long molecular chains. Acceptable shock wave devices are available from Seepex, Inc. of Enon, Ohio. In the present invention, a shock wave device (410) helps break up any wax and other 25-30 carbon chain molecules into shorter chain molecules.

As the pressurized polymerized output (331) enters the flash column (420), the pressure is reduced from a gauge pressure of about 5500 kPa (800 psig) to a gauge pressure of about 1380 kPa (200 psig), while the temperature is lowered to about 400° F. (205° C.). The decrease in temperature ends polymerization. Within flash column (420), lighter carbon chains, such as those with fewer than 12 carbons, are understood to vaporize, and can be collected through a vent and can be condensed through a condenser (430) as a fuel source such as gasoline. In the production of diesel fuel, 6 to 8% of polymerized output (331) is understood to vaporize in flash column (420). Traces of carbon dioxide and carbon monoxide are also vented off at this time. They can be collected or processed, if it is desired, to reduce greenhouse emissions. Carbon chains with more than 12 carbons tend to stay in liquid phase and can be collected as a final output fuel (421). Final output fuel (421) can be recycled advantageously as input to liquid feed (270), where it can serve as the required non-aqueous hydrocarbon solvent.

Typically, the weight of final output fuel (421) recycled and the weight of solid feedstock (201) input into size reduction section (200) of plant (10) should have about a 1 to 1 to a 1 to 2 ratio. Recycled final output fuel (421) acts as a heat source and provides initiators 281 to the feedstock stream.

The process described and claimed herein differs from the known Fischer-Tropsch process in certain key respects. The Fischer-Tropsch process starts with the combustion of a carbon-based organic compound in the presence of a supply of oxygen insufficient for a complete reaction, such that the combustion reaction produces principally carbon dioxide, carbon monoxide and hydrogen according to the general reaction:

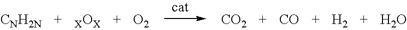

The ratio of combustion products in that process is varied with operating conditions, catalyst and pressure. The carbon monoxide (CO) and hydrogen are then purified and reacted further over different catalysts to produce a variety of carbon chain length hydrocarbons and alcohols. Some ethers and acids may also be formed. The Fischer-Tropsch process is a gas phase chemistry process.

The process of the present invention is preferably carried out in liquid anaerobic conditions where no free oxygen or air is permitted except the naturally entrained air in the raw organic materials. The process can be carried out in organic liquid form and no combustion is permitted to occur. The three-stage reaction involves converting the controlled moisture in the raw materials to a catalyst oxide and free hydrogen. In the second stage of a mode of practicing the process the catalysts react with the oxygen in water, the cellulose and plastics to form a catalyst oxide and unsaturated carbon chains, which react with the in situ free hydrogen to form, saturated multiple carbon chain radicals. In the third stage of a mode of practicing the process, the carbon chain radicals are reacted and polymerized to form iso, secondary and normal chains of controlled molecular weight. The three-step process can be carried out in continuous mode with different operating conditions for each step.

In a preferred embodiment, a ferrous metal separator (430) and a nonferrous metal separator (440) are utilized to remove and recycle initiators (281). Ferrous metal separator (430) can be assembled as a magnetic system that captures any iron or iron oxides in final output (421). The collected iron particles can be reduced back to their metallic form to be reused in the invention again, or sold as scrap. Non-ferrous metal separator (440) is a pressure filter type separator. Once separated, these non-ferrous metal particles can be washed and sold to the fertilizer industry.

Preferred embodiments of the invention are illustrated with reference to the following examples, which are presented by way of illustration only and should not be construed as limiting.

### EXAMPLE I

| | |
|---|---|
| Feedstock | 75 g (30% wood, 30% hay, 15% switch grass, |
| | 25% styrene/butadiene polymeric plastic) |
| Feedstock particle size | <300 microns |
| Moisture content | 15% |
| Initiator | 25 g of iron (Fe) |
| Initiator particle size | <300 microns |
| Solvent | 75 g of a mixture of organic liquids (alkanes |
| | of carbon number C5 to C2l) |
| Reaction temperature | 700-800° F. (370-425° C.) |
| Reaction duration | 3-20 minutes |
| Product: | 95% C3 to C21 molecules, 5% carbon number |
| 58.25 g | greater than 21 |

### EXAMPLE II

| | |
|---|---|
| Feedstock | 100 g of pure wood cellulose |
| Feedstock particle size | 500 microns or less |
| Moisture content | 20% |
| Imitator | 10 g of copper (Cu) and 10 g of zinc (Zn) |
| Initiator particle size | <200 microns |
| Solvent | 100 g of diesel fuel |
| Reaction temperature | 600° F. (315° C.) |
| Reaction duration | 10 minutes |
| Product: | 93% C6 to Cl2 alkanes and alkanols, 7% Cl2 to |
| 50.22 g | C21 alkanes and alkanols |

### EXAMPLE III

| | |
|---|---|
| Feedstock | 100 g of hay |
| Feedstock particle size | <100 microns |
| Moisture content | 7% |
| Imitator | 5 g of platinum (Pt) |
| Initiator particle size | <100 microns |
| Solvent | 100 g of combined liquid products of Example I |
| | and Example II |
| Reaction temperature | 850° F. (455° C.) |
| Reaction duration | 15 minutes |
| Product: | 94% C6 to Cl2 alkanes and alkanols, 6% Cl2 to |
| 56.58 g | C18 alkanes and alkanols |

The above examples show the variety of feedstocks that can be used in the system to produce different synthetic fuels in accordance with the invention. The type of synthetic fuel produced can be controlled by the type of initiator used as well as reaction conditions such as those within third reactor (330). It is understood that in first reactor (310) and second reactor (320), the feedstock is substantially liquefied by breaking intermolecular and intramolecular bonds using increased temperature and the reaction between the water and metal catalyst initiators. Feedstock is broken into short chain hydrocarbon moieties, ready to combine with others and polymerize. In the third reactor (330), the radicals automatically polymerize as the temperature and pressure are increased to optimize the reaction rate. At this point, initiators that played a significant role in creating hydrogen that attacks and breaks bonds have transformed from highly active chemical initiators to highly oxidized and therefore active surface catalysts that provide surface sites for polymerization. The initiators serve different purposes in the reformation, dehydration, rehydrogenation and polymerization reactions in the various reactors as their oxidation state alters with the reaction.

Table 1A, below, provides a summary of product that has been produced using a blend of tire chips, wood chips and straws after running the entire system for 24 hours. Runs 1 to 7 used iron and initiator/catalysts from tires (such as, for example, copper, zinc, silica, aluminum) to initiate and further reactions, with a feedstock comprised of about 25% tires, 50% grasses and straw and about 25% green wood chips, so that there was about 5-6% iron as initiator present. Instead of using tires as a source of initiators and of carbon-containing polymer, runs 8, 9 and 10 of Table 1B used about 6% by weight pure metal powder comprising 90% iron and 10% copper with a feedstock comprised of about 50% grass and straw (grass/straw) along with about 50% by weight green wood chips. Runs 11 to 13, also used metal powder at the ratio of 90% iron, 5% silica and 5% aluminum with the grass/straw and wood chips feedstock. The reaction times are listed, as well as temperature and pressure during reaction.

TABLE 1A

| | Run Number | | | | | | |
|---|---|---|---|---|---|---|---|
| | 1 | 2 | 3 | 4 | 5 | 6 | 7 |
| Reaction time | 12 | 12 | 12 | 12 | 12 | 8 | 13 |
| (minutes) | | | | | | | |
| Reaction | 260 | 315 | 370 | 400 | 425 | 425 | 315 |
| temperature | (500) | (600) | (700) | (750) | (800) | (800) | (600) |
| ° C. (° F.) | | | | | | | |
| Reaction | 20 | 25 | 30 | 40 | 50 | 50 | 30 |
| pressure (atm) | | | | | | | |
| Carbon number | Product Analysis | | | | | | |
| C1 | — | <.5 | 1 | 1 | 2 | — | — |
| C2 | — | <.5 | 3 | 4 | 4 | — | — |
| C3 | — | — | 3 | 3 | 4 | 1 | — |
| C4 | 2 | 3 | 3 | 3 | 3 | 3 | — |
| C5 | — | <1 | <1 | 1 | 3 | 1 | 3 |
| C6 | 2 | 3 | 5 | 5 | 8 | — | — |
| C8 | 2 | 2 | 2 | 26 | 20 | 2 | 9 |
| C10 | 4 | 6 | 18 | 25 | 21 | — | — |
| C12 | 39 | 61 | 52 | 20 | 33 | 35 | 27 |
| C14 | 10 | 17 | 9 | 6 | — | 5 | 11 |
| C16 | 13 | 1 | 2 | 2 | 1 | 17 | 10 |
| C18 | 18 | 1 | — | 1 | 1 | 19 | 26 |
| C20 | 5 | <1 | 1 | 1 | — | 9 | 21 |
| C22 | 4 | 3 | — | 1 | — | 9 | 1 |
| C24 | 1 | — | — | 1 | — | 4 | — |

TABLE 1B

| | Run Number | | | | | |
|---|---|---|---|---|---|---|
| | 8 | 9 | 10 | 11 | 12 | 13 |
| Reaction time | 8 | 10 | 12 | 6 | 8 | 10 |
| (minutes) | | | | | | |
| Reaction | 260 | 400 | 455 | 260 | 400 | 455 |
| temperature | (500) | (750) | (850) | (500) | (700) | (850) |
| ° C. (° F.) | | | | | | |
| Reaction | 40 | 45 | 50 | 30 | 40 | 50 |
| pressure | | | | | | |
| (atm) | | | | | | |
| Carbon number | Product Analysis | | | | | |
| C1 | — | — | 1 | — | Trace | 4 |
| C2 | — | — | 1 | — | Trace | 4 |
| C3 | — | — | 2 | — | 4 | 3 |
| C4 | <1 | 1 | 2 | — | 4 | 4 |
| C5 | <1 | 1 | 9 | 2 | 3 | 6 |
| C6 | 1 | 2 | 20 | 2 | 3 | 11 |
| C8 | 1 | 2 | 23 | 1 | 13 | 26 |
| C10 | 3 | 1 | 31 | 1 | 11 | 23 |
| C12 | 13 | 14 | 6 | 24 | 19 | 13 |
| C14 | 21 | 21 | 2 | 12 | 17 | 3 |
| C16 | 24 | 21 | 1 | 12 | 18 | 1 |
| C18 | 14 | 14 | 1 | 32 | 9 | <1 |
| C20 | 10 | 14 | — | 10 | 4 | <1 |
| C22 | 10 | 8 | — | 3 | 1 | — |
| C24 | 1 | 1 | 1 | 1 | 4 | — |

Each of the patents and articles cited herein is incorporated by reference. The use of the article “a” or “an” is intended to include one or more.

The foregoing description and the examples are intended as illustrative and are not to be taken as limiting. It is to be understood that ingredients or compounds recited in the singular are intended to include compatible mixtures of such ingredients wherever the sense permits. Still other variations within the spirit and scope of this invention are possible and will readily present themselves to those skilled in the art.

What is claimed is:

1. A system for producing a liquid combustible fuel, comprising:
a feed stream containing a slurry of feedstock pieces comprised of carbon-containing polymeric materials that are substantially free of each of halogen, sulfur and nitrogen atoms, a catalytic amount of metal pieces of Group VIII, IB, IIB, IIIA, or IVA metal particles comminuted to pass through a No. 18 Standard Sieve and water in a non-aqueous carrier liquid;
a reactor section, having an input end receiving the feed stream and an output end outputting a reacted feed stream and comprising one or more reactor vessels;
the one or more reactor vessels constructed to cause the carrier liquid to flow through at least one reactor vessel in substantially plug flow at a controlled flow velocity and residence time within the one or more reactors;
the temperature on the inside surface of the reactor being raised progressively and in a controlled manner to a temperature of about 250° to about 455° C. and a pressure of about 20 to about 50 atmospheres, at least one reactor having a device to measure the viscosity and the temperature of the contents exiting the reactor and a device to adjust the temperature of the contents of the reactor and the time it takes the carrier liquid to flow through the reactor based on the viscosity measurement; and
the metal pieces and water input at the input end of the reaction section present in sufficient quantity with respect to the feedstock particles to react and substantially turn the feedstock pieces into combustible liquid fuel at the output end of the reaction section.

2. The system of claim 1, wherein at least 80% of the feedstock pieces are particles smaller than about 500 microns in diameter.

3. The system of claim 1, wherein at least 80% of the feedstock pieces are particles smaller than about 300 microns in diameter.

4. They system of claim 1, wherein the feedstock carbon-containing polymeric materials are comprised of biomass including one or both of a cellulosic material and lignin.

5. The system of claim 1, wherein the carrier liquid is recycled liquid directly or indirectly from the output end of the reactor.

6. The system of claim 1, wherein the feedstock pieces comprise shredded tire particles, 80% or more of which have a particle diameter less than about 500 microns.

7. The system of claim 1, wherein the feedstock pieces comprise shredded tire particles, 80% or more of which have a particle diameter less than about 300 microns.

8. The system of claim 1, wherein the feedstock pieces comprise a combination of shredded tire particles and biomass that includes one or both of a cellulosic material and lignin.

9. The system of claim 1, wherein the reactor section comprises a first reactor vessel, at temperature and pressure conditions, wherein at least 80% of the feedstock pieces are liquefied because their polymer length is reduced compared to the length of the polymers in the particles entering the feed stream.

10. The system of claim 1, wherein the reactor section comprises a first reactor vessel, wherein the output temperature of the first reactor vessel is about 120° C. to about 230-260° C.

11. The system of claim 1, comprising at least two reactor vessels in series, wherein a liquid output flows from the first of the two to the second of the two reactor vessels and the output temperature in the second vessel is over about 260° C.

12. The system of claim 11, wherein there are at least three reactor vessels in series and the third of the three receives the output of the second vessel and the temperature of liquid output from the third of the three vessels is about 370° C. to about 455° C.

13. The system of claim 4, wherein the reactor section contains cellulose that underwent a dehydration reaction.

14. A system for producing combustible liquid fuel, comprising:
a feedstock stream of particles of carbon-containing polymeric materials comprised of waste plastic, tires or biomass including one or both of a cellulosic material and lignin dispersed with a hydrocarbon-based carrier liquid, metal particles and water in the form of a slurry;
one or more reactors having input ends and output ends, at least some of the reactors having electrical heat controls and internal augers.

15. A chemical reactor designed to produce liquid hydrocarbon fuel, comprising:
a non-vertical tube with a length to width ratio of about 5:1 to about 20:1, the tube having elements and an internal auger, the tube capable of containing flammable liquids over 455° C. and at a gauge pressure of about 5,500 kPa.

16. A chemical reactor, comprising:
a non-vertical tube;
an auger within the tube, the auger controlled to spin at a selected speed and move material within the reactor, in plug flow, to provide a selected residence time within the reactor;
a heating element to adjust the temperature within the reactor; the reactor constructed to achieve a reaction of over 455° C. at a gauge pressure of about 5,500 kPa and to move material within the reactor with a selected residence time of between 5 and 20 minutes.

17. The reactor of claim 16, comprising liquid hydrocarbon polymer and unoxidized or oxidized metal powders within the tube.

18. The reactor of claim 16, containing gasoline, diesel fuel or aircraft fuel within the tube.

19. The reactor of claim 16, comprising biomass particles including one or both of a cellulosic material and lignin in an organic liquid within the tube.

20. The reactor of claim 16, comprising ground up tires within the tube.

21. The reactor of claim 16, including a viscosity measuring device and a feedback system, so that the viscosity measurement affects the heat from the heating elements and/or the speed of the auger.

22. The reactor of claim 16, wherein the tube is substantially horizontal.
